(19) United States
(12) Patent Application Publication
(10) Pub. No.: US 2007/0106696 A1
(43) Pub. Date: May 10, 2007

(54) Method and system for generating a manual

(75) Inventor: Nabil Mesbah, Paris (FR)

Correspondence Address: DAVIDSON, DAVIDSON & KAPPEL, LLC, 485 SEVENTH AVENUE, 14TH FLOOR, NEW YORK, NY, 10018, US

(73) Assignee: ALSTOM Transport SA, Levallois-Perret (FR)

(21) Appl. No.: 11/591,201

(22) Filed: Nov. 1, 2006

(30) Foreign Application Priority Data
Nov. 2, 2005 (FR) 05 11168

(51) Int. Cl. G06F 17/00

(52) U.S. Cl. 707/104.1

(57) ABSTRACT

The present invention relates to a system for creating a manual from at least one item of information originating from a global data warehouse, each item of information from the global data warehouse being able to comprise a link to another item of information from the global data warehouse. The system comprises means for copying at least one item of information from the global data warehouse into the manual, and means for scanning the manual, and, for each link contained in a copied item of information: if the linked information has been copied into the manual, for replacing this link with an explicit reference at the location in the manual where it has been copied, if the linked information has not been copied into the manual, for deleting the link.

### FIELD OF THE INVENTION

The present invention relates to a method and a system for creating a manual.

The invention relates quite particularly to the field of creating technical manuals. A manual includes a document with a structured presentation of information describing a machine.

### BACKGROUND

In the prior art, an archivist wishing to produce a manual uses a data warehouse which contains items of information classified by type of information: drawing, maintenance procedure text, description of a component, etcetera.

A data warehouse is a data-processing means for organised storage of a set of data, or a set of data groups in which each group relates to a specific type of data (maintenance, component, etcetera). The storage is controlled either by a single item of software, or by a plurality of items of software, each one controlling a group of data.

A data warehouse generally includes one or more databases, within each of which the data are organised in accordance with a specific structure which generally relates to a technical storage means.

The archivist incorporates the relevant information for producing the desired manual in a manual structure which is generally imposed by the user of the machine.

Each item of information contained in the data warehouse may itself include a link to another item of information from the data warehouse.

In this manner, a problem of the prior art consists in that the manual generated by the archivist includes links to information outside the manuals, which is not acceptable.

### SUMMARY OF THE INVENTION

An object of the invention is to overcome this problem by proposing a method for assembling at least one item of information to be assembled in a data file which is independent of the data warehouse.

The present invention provides a method for creating a manual from at least one item of information originating from a global data warehouse, each item of information from the global data warehouse being able to include a link to another item of information from the global data warehouse, wherein it includes the steps involving:

copying at least one item of information from the global data warehouse into the manual,

scanning the manual and, for each link contained in a copied item of information:

if the linked information has been copied into the manual, replacing this link with an explicit reference at the location in the manual where it has been copied,

if the linked information has not been copied into the manual, deleting the link.

Owing to the invention, not only are the links to information outside the manual deleted, but the links to items of information within the file, that is to say, which are copied therein, are also updated. The file obtained is therefore both complete and independent.

A method according to the invention may further include one or more of the following features:

it includes the steps, prior to the step for copying at least one item of information, involving inserting, in the manual, a link to each item of information to be copied, scanning the manual, when a link is found, verifying that the information linked to the manual exists in the global data warehouse, and, if the information does not exist, deleting the link;

the manual is a data file of the XML type; and

the copying step involves copying each linked item of information in place of the link;

The invention also provides a system for creating a manual from at least one item of information originating from a global data warehouse, each item of information from the global data warehouse being able to include a link to another item of information from the global data warehouse, wherein it includes:

means for copying at least one item of information from the global data warehouse into the manual,

means for scanning the manual, and, for each link contained in a copied item of information: if the linked information has been copied into the manual, for replacing this link with an explicit reference at the location in the manual where it has been copied, if the linked information has not been copied into the manual, for deleting the link.

A system according to the invention may further include one or more of the following features:

it includes means for inserting, in the manual, a link to each item of information to be copied, and means for scanning the manual, when a link is found, verifying that the information linked to the manual exists in the global data warehouse, and, if the information does not exist, deleting the link;

the manual is a file of the XML type.

### BRIEF DESCRIPTION OF THE DRAWINGS

The invention will be better understood from the following description, given purely by way of example and with reference to the appended drawings, in which:

FIG. 1 is a schematic view illustrating a system for generating a manual according to the invention;

FIG. 2 is a schematic view of an information module; and

FIG. 3 is a block diagram illustrating the steps of a method for generating a manual carried out by the system of FIG. 1.

### DETAILED DESCRIPTION

In the following description, the data warehouses are databases. Of course, the invention can be directly applied to the case of data warehouses.

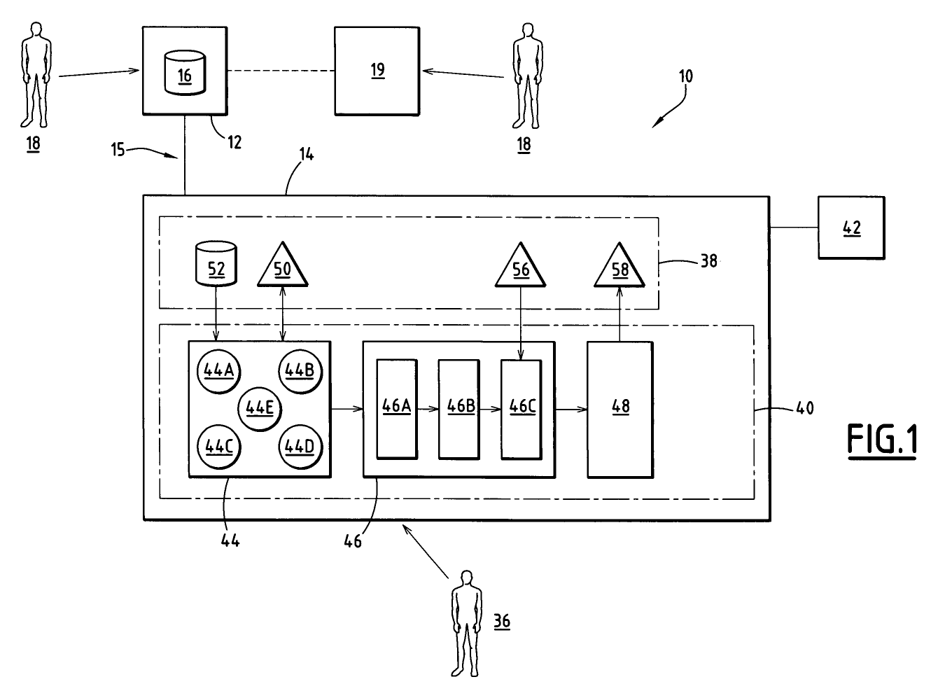

The system of FIG. 1, generally designated 10, includes two computers 12, 14 which communicate with each other by means of a data-processing network 15.

One of the computers 12 is a data server in which a database 16 is installed, which is referred to as the global base 16 and which contains items of information which each relate to at least one technical element of at least one machine.

The global base 16 is intended to be completed by a member of technical staff 18. The data server 12 thus includes a man/machine interface by means of which this member of technical staff 18 directly completes the global base 16. The data server 12 is further connected to a plurality of remote computers 19. The member of technical staff 18 who is not on the site where the data server 12 is located completes the global base 16 remotely by using these remote computers 19.

In the global base 16, the items of information are organised by means of encapsulation in a module.

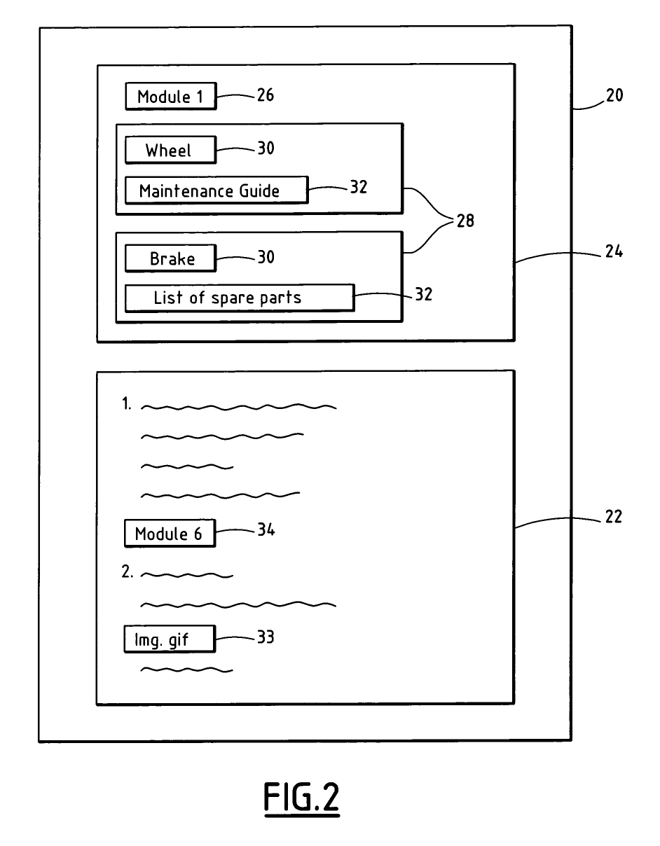

With reference to FIG. 2, each module 20 includes, on the one hand, a content 22 which includes information relating to one or more technical elements and, on the other hand, an identification unit 24 which contains items of data defining the module 20.

The identification unit 24 in particular includes a module identifier 26 and a portion, referred to as the environment portion 28, for each technical element to which the module 20, that is to say, the items of information 22 which it contains, relates.

Each environment portion 28 includes in particular an identifier 30 of the corresponding technical element, and an identifier 32 of a type of manual into which the content can be inserted, for the corresponding technical element. The types of manual are as follows: illustrated catalogue, maintenance guide which contains maintenance tasks, maintenance manual containing maintenance tools, list of spare parts. Of course, this list is non-limiting and other types of manual can be added according to requirements.

The content 22 of a module is either textual (description, maintenance procedure, etcetera.) or graphic (technical drawing, block diagram, etcetera). This content is structured. For example, a textual content includes indicators of logical portions: chapter paragraph, numbering step, etcetera.

The content may be static, the information is present in the module 20, or dynamic, the content includes a link 33 to the information stored outside the module 20.

For some modules of the global base 16, the content 22 thereof refers to one or more other contents of other modules. This reference is indicated by the presence of a link 34 to another module which includes the linked content. The link indicates an identifier 26 for the linked module.

With reference to FIG. 1 again, the other computer 14 is intended to be used by an archivist 36 who wishes to create a manual which includes a document having a structured presentation of information describing a machine, such as a carriage set of a train.

The computer 14 of the archivist includes means 38 for storing numerical data, for example, a hard disk, and processing means 40: microprocessor, RAM, etcetera, suitable for carrying out software programs, for example, recorded on the storage means 38. Furthermore, the computer 14 is connected to a printer 42.

Three software components 44, 46 and 48 are installed on the computer 14 of the archivist 36.

The first software component, designated 44, is designed for the creation of a file for a completed manual template 50, that is to say, containing information in the form of links.

The first software component 44 includes a man/machine interface 44A, by means of which the archivist 36 interacts with this component 44 in order to guide the archivist in creating the manual template. All the functions set out below require the intervention of the archivist 36 using this interface 44.

The first software component 44 first includes a function 44B for defining the manual type, allowing the archivist 36 to indicate the type of manual he wishes to generate.

Furthermore, the first software component 44 includes a function 44C for recovering a list of the modules contained in the global base 16 which are linked to the type of manual indicated.

A display function 44D displays the list of recovered modules, and displays a structure of the template opposite the list of modules.

This structure is blank when the function 44D is launched. The first software component 44 offers the alternative of creating the structure manually or importing a structure of a manual template file which has already been created.

Each module of the list can be moved to a logical portion of the structure by means of dragging and dropping. That is to say, the first software component 44 allows the selection of a tree module and the selection of a logical portion in the structure where the archivist 36 would like to deposit the module in order to associate them.

The first software component 44 includes a function 44E for creating a template file 50. In the example described, the file 50 is in XML format. It takes the structure indicated by the archivist 36 supplemented with links to the modules inserted by the archivist.

More precisely, the function for creating a template file 44E is designed to insert, for each module linked by the archivist 36, a link to the module in the portion of the structure of the associated template of the file 50. This means that a line which indicates the identifier 26 of the module is inserted in the XML file 50.

In this manner, the first software component 44 produces at the output a manual template file 50 in XML format including links to all the information which the archivist 20 wishes the manual to contain. The modules to which the template includes a link are referred to as modules which are directly linked, whilst the modules which are linked to the template only by means of one or several other modules, by means of links 34 between modules, are referred to as modules which are indirectly linked.

The first software component 44 is suitable for storing this output file 50 in the storage means 38 and launching the second software component 46 which will search for this file 50.

The first software component 44 is also designed to load a completed template XML file which has been recorded beforehand in the storage means 38 in order to be used by the second software component 46.

The second software component 46 is used to prepare for editing the manual. It expects at the input an XML file 50 of a completed manual template. In the example described, the component 46 takes the architecture of the free software COCOON (cocoon.apache.org), parametrising it for the specific requirements of the invention.

The editing preparation component 46 includes three consecutive stages, that is to say, carried out in this order, for processing the completed template file 50: a verification stage 46A, an assembly stage 46B and a formatting stage 46C.

The verification stage 46A is configured to scan the template file 50 and verify that each module which is directly linked to the template, that is to say, for which the template includes a link, exists in the global base 16. This stage 46A is also configured to delete the link when this module does not exist and insert an error message in its place.

The verification stage 46A is further configured to verify, if necessary, the dynamic content of the linked modules. This means that it is capable of verifying that the link 33 which a dynamic content includes does point towards a valid item of data.

The second assembly stage 46B is configured in order to carry out three operations.

First of all, it carries out an operation for copying into an intermediate database 52 the modules that are directly linked from the global base 16 to the storage means 38.

Then, it carries out an operation which involves copying, for each module which is directly linked, the information, that is to say, the content, which the module contains, in place of its link in the template file 50.

Finally, the third operation involves, when the preceding operation is complete, scanning the template file 50 in order to detect the links which it contains and which originate from the links 34 between modules, that is to say, which are contained in the information copied during the preceding operation. If the link 34 points towards a module which is also directly linked, this link 34 is replaced with a reference to the logical portion of the structure of the template where the information of the module has been inserted. If the link 34 points towards a module which is indirectly linked, that is to say, which the archivist has not inserted in the template, the link 34 is deleted.

The third formatting stage 46C is configured in order to format the verified and assembled template, using a style sheet 56 which associates a predetermined typographic style with each portion of the structure, of the template, or of the copied content. This style sheet indicates in particular the font, the size of the characters, the underlining etcetera, to be used for each logical portion of all of the template file 50: chapter, section, paragraph, informal note, highlighted text, etcetera.

This third stage 46C is also designed to control the third software component.

The third software component has the reference numeral 48 and is a peripheral unit for editing the manual from the template file 50 provided at the output of the second processing software component 46. In the example described, it is capable of generating a pdf document 58 and recording this document in the storage means 38. In this manner, the storage means 38 contain the final manuals, in the state as they are delivered to their respective client.

In other embodiments, the peripheral editing unit 48 is capable of producing an HTML file or Word file, etcetera.

Finally, the third software component 48 includes a function for controlling the printer 42 from the file 58 generated, in order to obtain a printed manual.

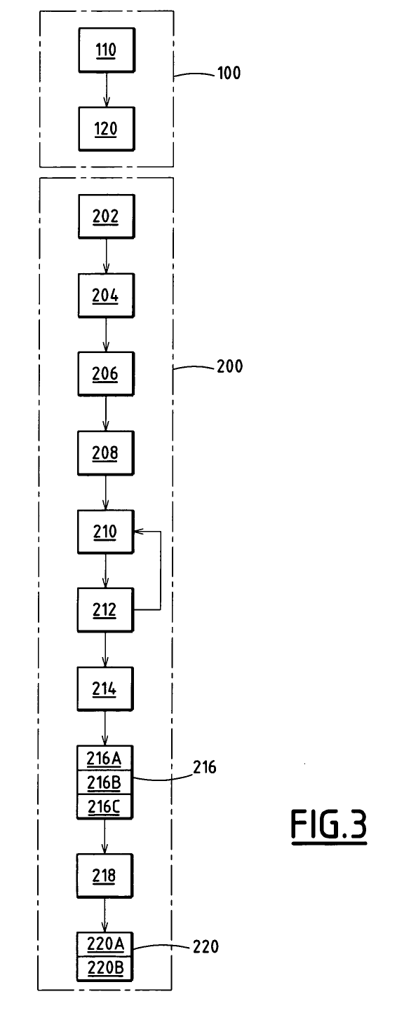

The method for generating a manual illustrated in FIG. 3 includes two main phases: a phase 100 for initialising the system 10 and a phase 200 for implementing this system 10. The implementation phase 200 is repeated by the archivist 36 for each creation of a new manual, whilst the initialisation phase 100 is carried out in a continuous manner, including during and after the implementation phases 200, by the members of technical staff 18, so that the global base 16 includes the latest information available.

The initialisation phase 100 includes a first step 110 which involves creating the global database 16, and a second step 120 which involves associating, in the global base 16, each module with the technical element to which the information it contains refers. During this step 120, the modules are also associated with at least one type of manual.

The implementation phase 200 includes a first step 202 during which the archivist 36 launches the first software component 44.

He carries out, during a step 204, the function 44B in order to indicate to the first software component 44 the type of manual which he wishes to create.

The first software component 44 carries out, during a step 206, the function 44C for recovering the list of modules linked to the type of manual indicated.

Then, during a step 208, the first software component 44 carries out the function 44D for displaying a blank template structure and the list of modules. The archivist also creates the structure during this step 208.

During a step 210, the archivist 20 completes the manual template by dragging and dropping the modules from the module list to a logical portion of the structure of the template.

The preceding step 210 is repeated as many times as the archivist 20 requires.

When the archivist 20 has finished the completion operation, he controls the first software component 44 so that it generates, during a step 212 which is carried out by the function 44E, an XML file 50 of a completed manual template. The first software component 44 stores this file in the storage means 38 and launches the second software component 46 in order to edit the manual template 50.

The editing is generally carried out directly after the step 210 for completing the template. However, the editing operation can also take place a long time, sometimes several months, after the template file has been created and stored. This is the case, for example, when the client wishes to obtain a new updated version of his manual.

The editing is carried out by the editing preparation component 46 and editing component 48, without the involvement of the archivist 36.

In this manner, the implementation phase 200 includes a step 214 for verification of the template file 50, carried out by the verification stage 46A.

There follows a step 216 for assembling the template, carried out by the assembly stage 46B. The three operations that this stage 46B is capable of carrying out are implemented. These three operations are illustrated in FIG. 3 by the sub-steps 216A, 216B and 216C.

The formatting stage 46C then carries out the formatting (step 218) of the manual template using the style sheet 56, which has been specified beforehand by the archivist 36.

During a final control step 220, the second software component 46 controls the third component 48 so that it carries out two operations. Firstly, it generates (220A) the final manual in pdf format from the template file obtained following the processing operations carried out by the various stages of the software component 46. The pdf file 58 which constitutes the final manual is stored in the storage means 38. Then, the peripheral editing unit 48 controls (220B) the printer 42 in order to print the file and obtain the final printed manual.

The final manual is independent of the global base 16, that is to say, the information that the archivist 31 wished it to contain are not linked to this global base 16.

As has been explained with reference to FIG. 1, controlling the peripheral editing unit can, in other embodiments, generate the manual in html or Word format, depending on the nature of the peripheral unit 48 used, in order to then be printed by the printer 42.

1-9. (canceled)

10. A method for creating a manual from at least one item of information originating from a global data warehouse, each item of information from the global data warehouse being able to comprise a link to another item of information from the global data warehouse, the method comprising:
copying at least one item of information from the global data warehouse into the manual; and
scanning the manual, and, for each link contained in a copied item of information:
if the linked information has been copied into the manual, replacing this link with an explicit reference at the location in the manual where it has been copied, and
if the linked information has not been copied into the manual, deleting the link.

11. The method according to claim 1, comprising prior to the step of copying at least one item of information:
inserting, in the manual, a link to each item of information to be copied,
scanning the manual and, when a link is found, verifying that the information linked to the manual exists in the global data warehouse,
if the information does not exist, deleting the link.

12. Method according to claim 10, wherein the manual is a XML data file.

13. Method according to claim 11, wherein the manual is a XML data file.

14. Method according to claim 11, wherein the copying step includes copying each linked item of information in place of the link.

15. A system for creating a manual from at least one item of information originating from a global data warehouse, each item of information from the global data warehouse being able to comprise a link to another item of information from the global data warehouse, the system comprising:
means for copying at least one item of information from the global data warehouse into the manual,
means for scanning the manual, and, for each link contained in a copied item of information:
if the linked information has been copied into the manual, for replacing this link with an explicit reference at the location in the manual where it has been copied,
if the linked information has not been copied into the manual, for deleting the link.

16. The system according to claim 15, further comprising:
means for inserting, in the manual, a link to each item of information to be copied,
means for scanning the manual, when a link is found, verifying that the information linked to the manual exists in the global data warehouse, and, if the information does not exist, deleting the link.

17. The system according to claim 15, wherein the manual is a XML file.

18. The system according to claim 16, wherein the manual is a XML file.

19. A system for creating a manual from at least one item of information originating from a global data warehouse, each item of information from the global data warehouse being able to comprise a link to another item of information from the global data warehouse, the system comprising:
a computer configured to:
copy at least one item of information from the global data warehouse into the manual, scanning the manual; and,
for each link contained in a copied item of information:
if the linked information has been copied into the manual, replace this link with an explicit reference at the location in the manual where it has been copied,
if the linked information has not been copied into the manual, delete the link.
